(19) United States
(12) Patent Application Publication
(10) Pub. No.: US 2022/0345372 A1
(43) Pub. Date: Oct. 27, 2022

(54) NETWORK MANAGEMENT APPARATUS, METHOD, AND PROGRAM

(71) Applicant: NIPPON TELEGRAPH AND TELEPHONE CORPORATION, Tokyo (JP)

(72) Inventors: Kimihiko FUKAMI, Musashino-shi, Tokyo (JP); Masataka SATO, Musashino-shi, Tokyo (JP); Kenichi TAYAMA, Musashino-shi, Tokyo (JP); Kenji MURASE, Musashino-shi, Tokyo (JP); Shohei NISHIKAWA, Musashino-shi, Tokyo (JP)

(73) Assignee: NIPPON TELEGRAPH AND TELEPHONE CORPORATION, Tokyo (JP)

(21) Appl. No.: 17/640,981

(22) PCT Filed: Sep. 12, 2019
(86) PCT No.: PCT/JP2019/035955

§ 371 Date: Mar. 7, 2022

(51) Int. Cl. H04L 41/12; H04L 41/084; H04L 41/14

(52) U.S. Cl. CPC H04L 41/12; H04L 41/0843; H04L 41/145

(57) ABSTRACT

A network management device according to an embodiment includes: a first storage unit that stores entities representing substances of information objects in a network; a second storage unit that stores information on a start point and an end point of the network; a third storage unit that stores information on a rule of a path indicating types of and a connection order of a plurality of communication devices provided between the start point and the end point of the network; path calculation processing means for obtaining the information on the start point and the end point of the network from the second storage unit, and calculating, based on the entities stored in the first storage unit, a plurality of physical-layer paths between the start point and the end point of the network and obtaining entities between the start point and the end point in each of the plurality of physical-layer paths from the first storage unit; and path assessment processing means for assessing a path indicated by the obtained entities as a path that meets the rule if the path, indicating types of and a connection order of a plurality of communication devices provided between the start point and the end point of the network in the path, meets the rule stored in the third storage unit.

### TECHNICAL FIELD

Embodiments of the present invention relate to a network management device, method, and program.

### BACKGROUND ART

To manage a path in physical and logical layers of a network (NW) made up of different types of NW devices, some techniques allow network management information (entities or substances) in the logical layers to be automatically generated from specifications (specs) defining the logical layers (for example, see Non Patent Literature 1).

### CITATION LIST

### Non Patent Literature

Non Patent Literature 1: Study on Automatic Generation of Network Management Information Based on External Specification Definitions, The Institute of Electronics, Information and Communication Engineers (IEICE) general conference, B-14-12 (2019, 03)

### SUMMARY OF INVENTION

### Technical Problem

In a network facility that provides communication services such as telephone or Internet Protocol (IP) services, a network may be reconstructed for node switching or path modification. Before such reconstruction, a network designer may desire to grasp, from design information, pre- and post-reconstruction paths in physical and logical layers between a source device and a destination device.

To this end, conventional techniques require the designer to grasp pre- and post-reconstruction paths in physical-layer from the design information and manually input physical- and logical-layer management information (physical entities and logical entities).

The designer also has to manually obtain the pre- and post-reconstruction physical paths.

As above, conventional techniques impose a heavy workload associated with network path setting.

An object of the present invention, which has been made in view of the above circumstances, is to provide a network management device, method, and program that enable reducing the workload associated with network path setting.

### Solution to Problem

A network management device according to an aspect of the present invention includes: a first storage unit that stores entities representing substances of information objects in a network; a second storage unit that stores information on a start point and an end point of the network; a third storage unit that stores information on a rule of a path indicating types of and a connection order of a plurality of communication devices provided between the start point and the end point of the network; path calculation processing means for obtaining the information on the start point and the end point of the network from the second storage unit, and calculating, based on the entities stored in the first storage unit, a plurality of physical-layer paths between the start point and the end point of the network and obtaining entities between the start point and the end point in each of the plurality of physical-layer paths from the first storage unit; and path assessment processing means for assessing a path indicated by the entities obtained by the path calculation processing means as a path that meets the rule if the path, indicating types of and a connection order of a plurality of communication devices provided between the start point and the end point of the network in the path, meets the rule stored in the third storage unit.

A network management method according to an aspect of the present invention is performed by a network management device including: a first storage unit that stores first entities representing substances of information objects in a network; a second storage unit that stores information on a start point and an end point of the network; and a third storage unit that stores information on a rule of a path indicating types of and a connection order of a plurality of communication devices provided between the start point and the end point of the network. The method includes: performing path calculation processing including obtaining the information on the start point and the end point of the network from the second storage unit, and calculating, based on the entities stored in the first storage unit, a plurality of physical-layer paths between the start point and the end point of the network and obtaining entities between the start point and the end point in each of the plurality of physical-layer paths from the first storage unit; and performing path assessment processing including assessing a path indicated by the entities obtained in the path calculation processing as a path that meets the rule if the path, indicating types of and a connection order of a plurality of communication devices provided between the start point and the end point of the network in the path, meets the rule stored in the third storage unit.

### Advantageous Effects of Invention

The present invention enables reducing the workload associated with network path setting.

### BRIEF DESCRIPTION OF DRAWINGS

FIG. 1 is a block diagram showing an exemplary hardware configuration of a network management system 10 according to an embodiment of the present invention.

FIG. 2 is a diagram showing an exemplary software configuration of the network management system 10 according to an embodiment of the present invention.

FIG. 3 is a diagram showing a table of exemplary network configuration modeling applicable to network management devices.

FIG. 4 is a diagram showing exemplary processes of performing preliminary operations in the network management system according to an embodiment of the present invention.

FIG. 5 is a diagram showing exemplary processes of performing preliminary operations in the network management system according to an embodiment of the present invention.

FIG. 6 is a diagram for describing exemplary path calculation and path assessment.

FIG. 7 is a diagram for describing exemplary path calculation and path assessment.

FIG. 8 is a diagram showing exemplary input provided by a spec input unit and an entity input unit.

FIG. 9 is a diagram showing exemplary input provided by an accommodation information input unit.

FIG. 10 is a diagram showing a table of exemplary accommodation information.

FIG. 11 is a diagram showing exemplary input provided by a device configuration rule input unit.

FIG. 12 is a diagram showing a table of an exemplary device configuration rule.

FIG. 13 is a diagram for describing exemplary path selection by a path calculation unit.

FIG. 14 is a diagram for describing exemplary path selection by a path assessment unit.

FIG. 15 is a flowchart showing an exemplary process of processing operations of the path calculation unit and the path assessment unit.

FIG. 16 is a diagram showing an exemplary managed network.

FIG. 17 is a diagram showing a table of exemplary physical specs input by the spec input unit.

FIG. 18 is a diagram showing a table of exemplary logical specs input by the spec input unit.

FIG. 19 is a diagram showing a table of exemplary logical specs input by the spec input unit.

FIG. 20 is a diagram showing exemplary correspondences between the managed network and the physical specs.

FIG. 21 shows exemplary physical entity registration.

FIG. 22 shows exemplary physical entity registration.

FIG. 23 shows exemplary physical entity registration.

FIG. 24 is a diagram showing exemplary accommodation information setting.

FIG. 25 is a diagram showing exemplary accommodation information setting.

FIG. 26 is a diagram showing exemplary device configuration rule setting.

FIG. 27 is a diagram showing exemplary device configuration rule setting.

FIG. 28 is a diagram showing exemplary path calculation.

FIG. 29 is a diagram showing exemplary path calculation.

FIG. 30 is a diagram for describing exemplary logical entity addition.

### DESCRIPTION OF EMBODIMENTS

Embodiments according to the present invention will be described below with reference to the drawings.

### (Configurations)

### (1) Hardware Configuration

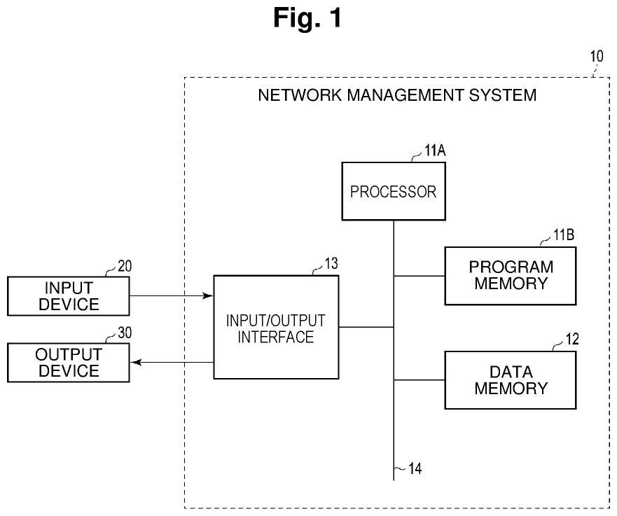

FIG. 1 is a block diagram showing an exemplary hardware configuration of a network management system 10 according to an embodiment of the present invention.

The network management system (a network management device) 10, implemented by a server computer or a personal computer for example, includes a hardware processor 11A such as a central processing unit (CPU). The network management system 10 also includes a program memory 11B, a data memory 12, and an input/output interface 13 that are connected to the hardware processor 11A via a bus 14.

An input device 20 such as a keyboard, and an output device 30 are attached to the network management system 10. The input device 20 and the output device 30 may be connected to the input/output interface 13. The program memory 11B is a non-transitory, tangible computer-readable storage medium that uses, for example, a combination of nonvolatile memory capable of random reading and writing, such as a hard disk drive (HDD) or a solid state drive (SSD), and nonvolatile memory such as ROM. The program memory 11B stores programs necessary for performing various control processes according to an embodiment.

The data memory 12 is a tangible computer-readable storage medium that uses, for example, a combination of nonvolatile memory as above and volatile memory such as random access memory (RAM). The data memory 12 is used to store various sorts of data obtained or generated during various processes.

### (2) Software Configuration

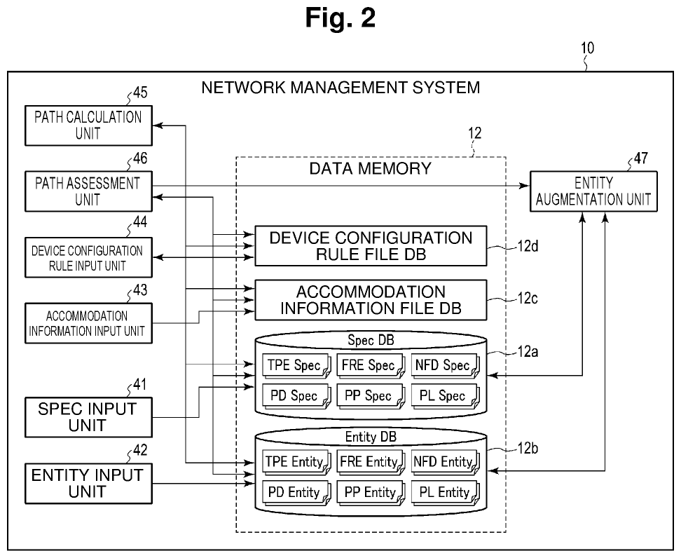

FIG. 2 is a diagram showing an exemplary software configuration of the network management system 10 according to an embodiment of the present invention. FIG. 2 shows the software configuration of the network management system 10 in association with the hardware configuration shown in FIG. 1.

As shown in FIG. 2, the network management system 10 may be configured as a data analysis device that includes software-based processing function units: a spec (specification) input unit 41, an entity input unit 42, an accommodation information input unit 43, a device configuration rule input unit 44, a path calculation unit 45, a path assessment unit 46, an entity augmentation unit 47, a spec database (DB) 12a, an entity DB 12b, an accommodation information file DB 12c, and a device configuration rule file DB 12d.

The spec DB 12a, the entity DB 12b, the accommodation information file DB 12c, and the device configuration rule file DB 12d in the network management system 10 shown in FIG. 2 may be implemented using the data memory 12 shown in FIG. 1. These databases, however, do not need to be internal to the network management system 10 but may be provided in an external storage medium such as a universal serial bus (USB) memory or in a storage device such as a cloud database server, for example.

The above processing function units of the spec input unit 41, the entity input unit 42, the accommodation information input unit 43, the device configuration rule input unit 44, the path calculation unit 45, the path assessment unit 46, and the entity augmentation unit 47 are implemented by causing the hardware processor 11A to read and execute programs stored in the program memory 11B.

Some or all of these processing function units may also be implemented in various other forms, including integrated circuits such as an application specific integrated circuit (ASIC) and a field-programmable gate array (FPGA). The entity input unit 42, the accommodation information input unit 43, and the device configuration rule input unit 44 may be implemented using the input device 20 and the output device 30.

Network management information (entities or substances) managed by the network management system 10 include the following types of information.

Physical-layer elements include PD (Physical Device), PP (Physical Port), and PL (Physical Link) entities (information objects). Logical-layer elements include TL (Topological Link), NFD (Network Forwarding Domain), TPE (Termination Point Encapsulation), and FRE (Forwarding Relationship Encapsulation) entities. FRE entities include NC (Network Connection), LC (Link Connect), and XC (Cross (X) Connect) entities. This allows organized representation of physical- and logical-layer elements.

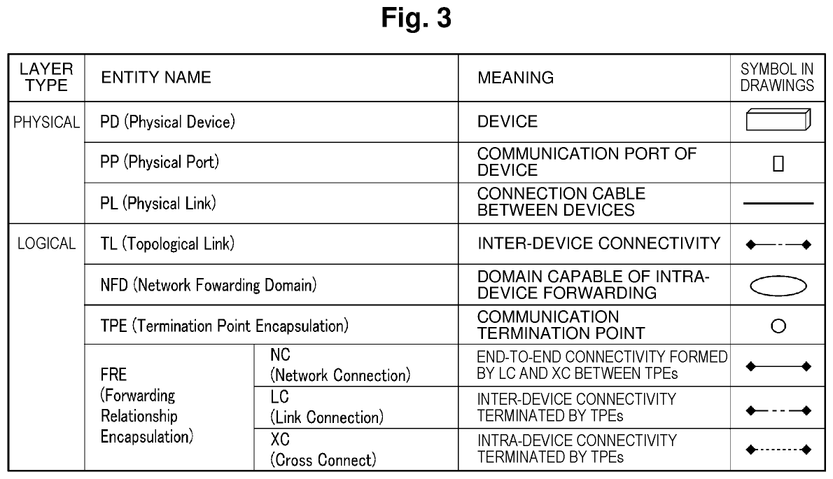

Modeling a NW configuration in physical and logical layers will be described. FIG. 3 is a diagram showing a table of exemplary network configuration modeling applicable to network management devices.

As shown in FIG. 3, the names of physical-layer entities are classified into PD, PP, and PL. The following shows the correspondence “entity name: meaning” for each entity name.
PD (Physical Device): a device
PP (Physical Port): a communication port of a device
PL (Physical Link): a connection cable between devices

As shown in FIG. 3, the names of logical-layer entities are classified into TL, NFD, TPE, and FRE (NC, LC, and XC). The following shows the correspondence “entity name: meaning” for each entity name.
TL (Topological Link): inter-device connectivity
NFD (Network Forwarding Domain): a domain capable of intra-device forwarding
TPE (Termination Point Encapsulation): a communication termination point
NC (Network Connection) of FRE (Forwarding Relationship Encapsulation): end-to-end connectivity formed by LC and XC between TPEs
LC (Link Connect) of FRE: inter-device connectivity terminated by TPEs
XC (Cross Connect) of FRE: intra-device connectivity terminated by TPEs

(Execution Processes)

Now, exemplary execution processes according to an embodiment of the present invention will be described.

### (Preliminary Operations)

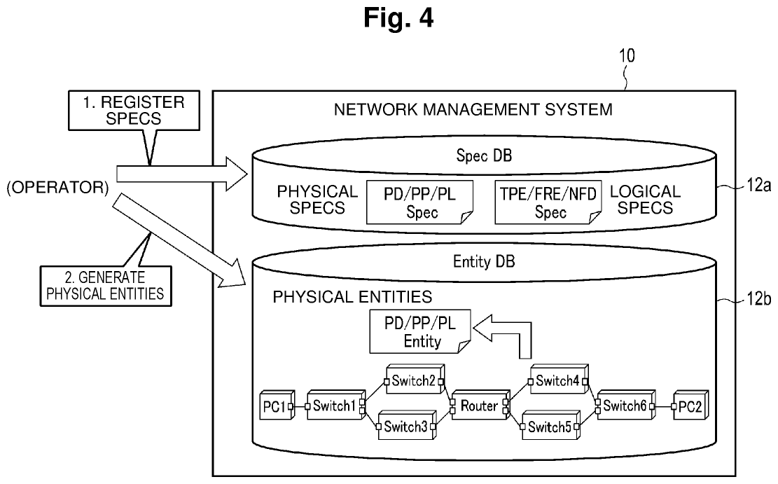

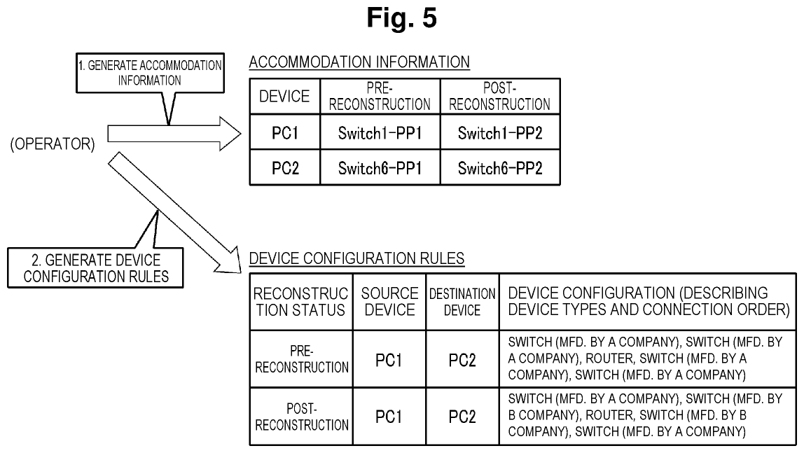

FIGS. 4 and 5 are diagrams showing exemplary processes of performing preliminary operations in the network management system according to an embodiment of the present invention.

(1) As shown in FIG. 4, through an operator's input operations, specifications defining a network before and after reconstruction are registered in the spec DB 12a of the network management system 10. The specifications registered include PD/PP/PL specs and TPE/FRE/NFD specs.

(2) As shown in FIG. 4, through the operator's input operations, physical-layer entities (which may be referred to as physical entities) are generated and stored in the entity DB 12b of the network management system 10. The entities stored include PD/PP/PL entities.

(3) As shown in FIG. 5, through the operator's input operations, accommodation information may be generated in advance for each of the network reconstruction statuses, i.e., pre-reconstruction and post-reconstruction. The accommodation information indicates ports of devices that accommodate the source device and the destination device (which may be collectively referred to as source and destination devices) involved in communication. The accommodation information generated may be stored in the accommodation information file DB 12c.

(4) As shown in FIG. 5, through the operator's input operations, device configuration rules may be generated in advance. Each device configuration rule indicates the network reconstruction status, and the source and destination device names and the device configuration before or after the reconstruction of the network. The device configuration rules may be stored in the device configuration rule file DB 12d. The device configuration in each device configuration rule includes the definition of path information, indicating the types of and the connection order of the devices between the source and destination devices. It is assumed here that the relationship between each reconstruction status and the source and destination devices defined in the accommodation information is the same as the relationship between each reconstruction status and the source and destination devices defined in the device configuration rules.

(Path Selection Operations: Path Calculation and Path Assessment)

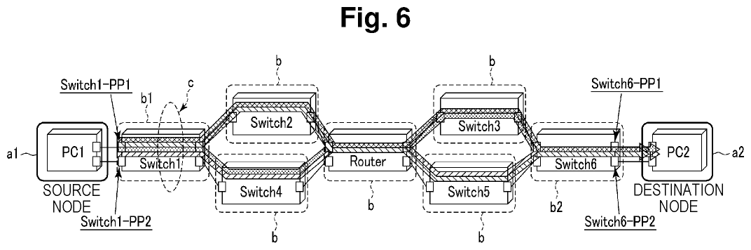

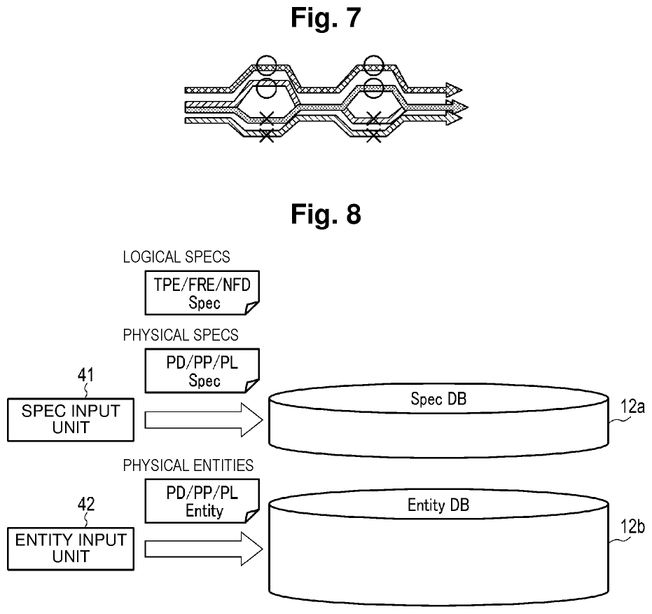

FIGS. 6 and 7 are diagrams for describing exemplary path calculation and path assessment.

It is assumed here that, as shown in FIG. 6, the network managed by the network management system (the network management device) includes six Ethernet (R) switches (which may hereinafter be simply referred to as switches) Switch1, Switch2, Switch3, Switch5, and Switch6 and one IP router (which may hereinafter be simply referred to as a router) Router between two personal computers (PCs) PC1 and PC2.

In this managed network, one end of Switch1 is communicatively connected to PC1, one end of each of Switch2 and Switch4 is communicatively connected to the other end of Switch1 in parallel, and one end of Router is communicatively connected to the other end of each of Switch2 and Switch4. One end of each of Switch3 and Switch5 is communicatively connected to the other end of Router in parallel, one end of Switch6 is communicatively connected to the other end of each of Switch3 and Switch5, and PC2 is communicatively connected to the other end of Switch6.

(1) The path calculation unit 45 obtains (a) and (b) below from the accommodation information.

(a) an accommodating device (e.g., Switch1 surrounded by b1 shown in FIG. 6) (referred to as an accommodating device A herein) and a port thereof (e.g., Switch1-PP1 shown in FIG. 6) that accommodate the source device (PC1) (a1 shown in FIG. 6)

(b) an accommodating device (e.g., Switch6 surrounded by b2 shown in FIG. 6) (referred to as an accommodating device B herein) and a port thereof (e.g., Switch6-PP1 shown in FIG. 6) that accommodate the destination device (PC2) (a2 shown in FIG. 6)

(2) The path calculation unit 45 obtains, from the device configuration rules, a device configuration (the device types and the connection order of a PD spec group) (e.g., b, b1, or b2 shown in FIG. 6) corresponding to the accommodating devices A and B and to the reconstruction status (pre- or post-reconstruction). In the example shown in FIG. 6, Switch1, Switch2, Switch3, Switch6, and Router are used before the reconstruction. The reconstruction causes Switch2 and Switch3 in use to be replaced by Switch4 and Switch5, so that Switch1, Switch4, Switch5, Switch6 and Router are used after the reconstruction.

(3) The path calculation unit 45 obtains, from the connection relationships of PP entities and PL entities, paths from PP of the accommodating device A to PP of the accommodating device B (e.g., c shown in FIG. 6).

(4) The path assessment unit 46 checks whether the PD specs and the connection order of the devices in each path obtained in (3) are the same as the device types and the connection order of the PD spec group obtained in (2). The path assessment unit 46 then identifies any identical path, for example a path marked with O but not with x as shown in FIG. 7, as an appropriate path.

(5) The entity augmentation unit 47 generates logical entities from logical specs corresponding to the physical entities in the path identified in (4).

Now, details of the above preliminary operations will be described. FIG. 8 is a diagram showing exemplary input provided by the spec input unit and the entity input unit.

The spec input unit 41 stores, in the spec DB 12a, the physical specs (PD/PP/PL specs) and the logical specs (TPE/FRE/NFD specs) in the managed NW.

The entity input unit 42 stores, in the entity DB 12b, the physical entities (PD/PP/PL entities) in the managed NW.

The spec DB 12a and the entity DB 12b may be RDBs or may be NoSQL DBs.

In one example in which these DBs are relational databases (RDBs), SQL may be used to store the physical spec data in the spec DB 12a and to store the physical entity data in the entity DB 12b.

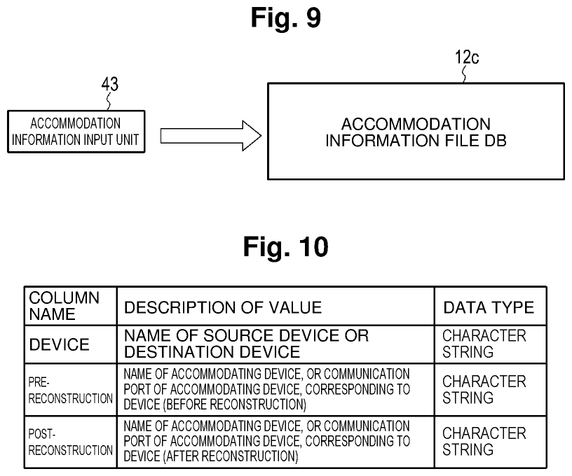

FIG. 9 is a diagram showing exemplary input provided by the accommodation information input unit.

The accommodation information input unit 43 inputs, to the accommodation information file DB 12c, the accommodating devices for the source and destination devices, or the communication ports of the accommodating devices, as accommodation information.

FIG. 10 is a diagram showing a table of exemplary accommodation information.

As shown in FIG. 10, the items (schema) stored as the accommodation information include column name, description of value, and data type.

The following shows the correspondences among column name, description of value, and data type in the accommodation information in the example shown in FIG. 10.

device: the name of the source or destination device: character string

pre-reconstruction: the name of an accommodating device, or a communication port of the accommodating device, corresponding to “device” (before reconstruction): character string

post-reconstruction: the name of an accommodating device, or a communication port of the accommodating device, corresponding to “device” (after reconstruction): character string

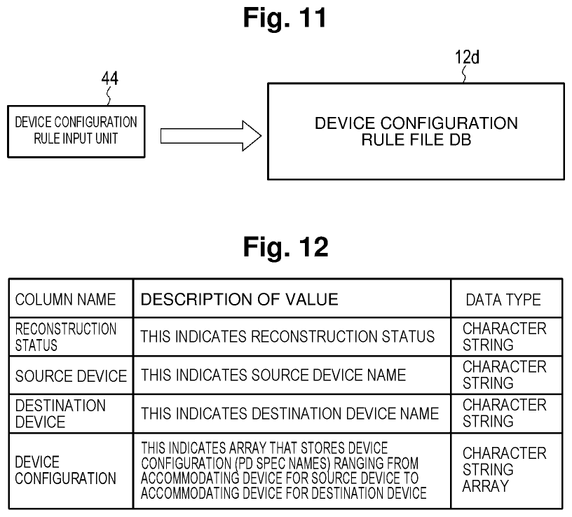

FIG. 11 is a diagram showing exemplary input provided by the device configuration rule input unit.

The device configuration rule input unit 44 stores, in the device configuration rule file DB 12d, each device configuration ranging from the accommodating device for the source device to the accommodating device for the destination device.

FIG. 12 is a diagram showing a table of an exemplary device configuration rule.

As shown in FIG. 12, the items (schema) stored as the device configuration rule includes column name, description of value, and data type.

The following shows the correspondences among column name, description of value, and data type in the device configuration rule in the example shown in FIG. 12.

reconstruction status: this indicates the reconstruction status: character string

source device: this indicates the source device name: character string

destination device: this indicates the destination device name: character string

device configuration: this indicates an array that stores a device configuration (PD spec names) ranging from the accommodating device for the source device to the accommodating device for the destination device: character string array

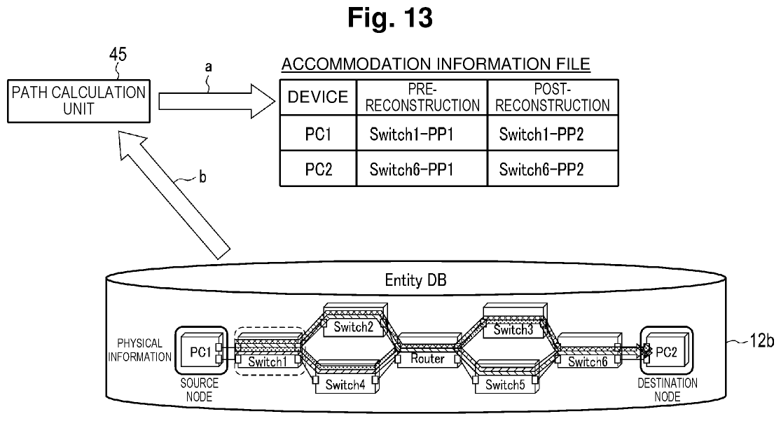

FIG. 13 is a diagram for describing exemplary path selection by the path calculation unit.

The path calculation unit 45 obtains, from the accommodation information file DB 12c, the port of the device accommodating the source device and the port of the device accommodating the destination device for a reconstruction status (pre- or post-reconstruction) (“a” shown in FIG. 13).

The path calculation unit 45 obtains, from the connection relationships of entities stored in the entity DB 12b, all paths that can be followed from the port of the device accommodating the source device (which may be referred to as a source accommodating port) to the port of the device accommodating the destination device (which may be referred to as a destination accommodating port) for the reconstruction status (pre- or post-reconstruction). The path calculation unit 45 obtains PD, PL, and PP entities in each of these paths from the entity DB 12b (“b” shown in FIG. 13).

The path calculation unit 45 may select the paths using, for example, the Dijkstra's algorithm applicable to the single-source shortest path problem.

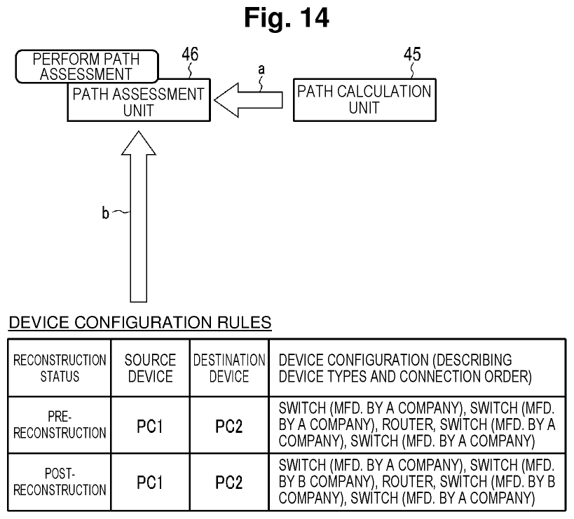

FIG. 14 is a diagram for describing exemplary path selection by the path assessment unit.

The path assessment unit 46 obtains the PD entities in each path obtained by the path calculation unit 45 and stores PD specs corresponding to these entities in an array, which will be referred to as a calculated array (“a” shown in FIG. 14).

The path assessment unit 46 obtains, from the device configuration rule file DB 12d, a device configuration corresponding to the reconstruction status, source device, and destination device for the calculated arrays. From this device configuration, the path assessment unit 46 obtains a PD spec array to be used as a rule array (“b” shown in FIG. 14).

The path assessment unit 46 compares the PD specs in one of the calculated arrays with the PD specs in the rule array. If the two arrays indicate the same PD specs in the same order, the path assessment unit 46 selects (assesses) this path obtained by the path calculation unit 45 as a path that meets the device configuration rule. If the compared PD specs or their orders are different, the path assessment unit 46 performs the path selection process for the next path.

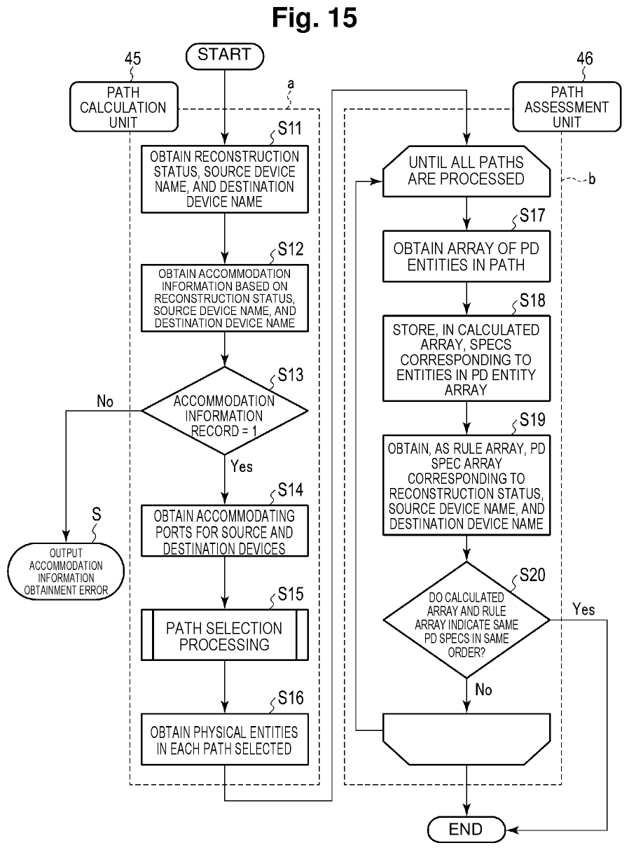

FIG. 15 is a flowchart showing an exemplary process of processing operations of the path calculation unit and the path assessment unit. These processing operations are divided into steps performed by the path calculation unit 45 (“a” shown in FIG. 15) and steps performed by the path assessment unit 46 (“b” shown in FIG. 15).

First, the path calculation unit 45 obtains the current reconstruction status, source device name, and destination device name (S11). The path calculation unit 45 attempts to obtain, from the accommodation information file DB 12c, the ports of the devices accommodating the source device and the destination device for this reconstruction status (S12).

If a relevant accommodation information record is found (Yes at S13), the path calculation unit 45 obtains, from the accommodation information file DB 12c, the ports accommodating the respective source and destination devices (S14). If no relevant accommodation information record is found (No at S13), a message or some other notification is output to indicate an accommodation information obtainment error.

The path calculation unit 45 uses an algorithm for solving the shortest path problem or some other means to obtain (select) all paths from the source accommodating port to the destination accommodating port for this reconstruction status (S15). The path calculation unit 45 obtains the physical entities in each of these paths from the entity DB 12b (S16).

The path assessment unit 46 then performs a loop process from S17 to S20 to be described below until all the paths are processed.

The path assessment unit 46 obtains an array of PD entities in one of the paths (S17) and stores PD specs corresponding to entities in this PD entity array in a calculated array (S18).

The path assessment unit 46 obtains, as a rule array, a PD spec array corresponding to the reconstruction status, source device name, and destination device name for the calculated array (S19).

If the calculated array does not indicate the same PD specs in the same order as the rule array (No at S20), the process returns to the start of the loop, where the path assessment unit 46 repeats the process starting at S17 for another path. If the calculated array indicates the same PD specs in the same order as the rule array (Yes at S20), the path assessment unit 46 assesses the path corresponding to the calculated array as a path that meets the device configuration rule. The process thus terminates.

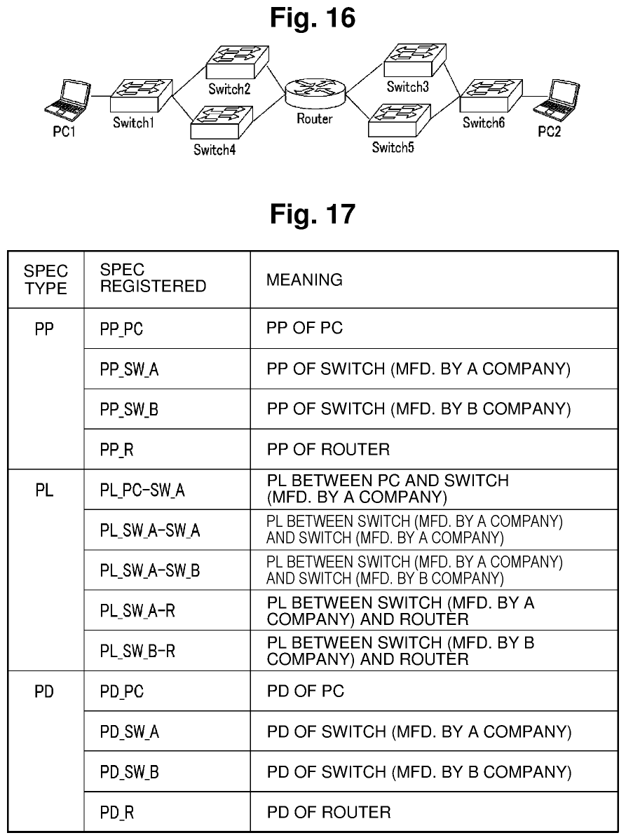

Now, a detailed example of processing by the network management system will be described. FIG. 16 is a diagram showing an exemplary managed network.

As shown in FIG. 16, one end of Switch1 is communicatively connected to PC1 of the two PCs, PC1 and PC2. One end of each of Switch2 and Switch3 is communicatively connected to the other end of Switch1 in parallel. One end of Router is communicatively connected to the other end of each of Switch2 and Switch3.

One end of each of Switch4 and Switch5 are communicatively connected to the other end of Router in parallel. One end of Switch6 is communicatively connected to the other end of each of Switch4 and Switch5. PC2 is communicatively connected to the other end of Switch6. The following describes processing for managing this network.

It is assumed that Switch1, Switch2, Switch3, and Switch6 are switches manufactured by A company, and Switch4 and Switch5 are switches manufactured by B company.

(Registering Physical Specs <Preliminary Operations>)

FIG. 17 is a diagram showing a table of exemplary physical specs input by the spec input unit. The spec input unit 41 preparatorily registers the physical specs shown in FIG. 17 in the spec DB 12a through the operator's operations.

Each physical spec includes the spec type, the physical spec registered, and the meaning.

The following shows the correspondences “expression of spec registered: meaning” for each of the types PP, PL, and PD of the physical specs registered in the example shown in FIG. 17.

(PP)

PP_PC: PP of a PC

PP_SW_A: PP of a switch (manufactured by A company)

PP_SW_B: PP of a switch (manufactured by B company)

PP_R: PP of a router

(PL)

PL_PC-SW_A: PL between a PC and a switch (manufactured by A company)

PL_SW_A-SW_A: PL between a switch (manufactured by A company) and a switch (manufactured by A company)

PL_SW_A-SW_B: PL between a switch (manufactured by A company) and a switch (manufactured by B company)

PL_SW_A-R: PL between a switch (manufactured by A company) and a router

PL_SW_B-R: PL between a switch (manufactured by B company) and a router

(PD)

PD_PC: PD of a PC

PD_SW_A: PD of a switch (manufactured by A company)

PD_SW_B: PD of a switch (manufactured by B company)

PD_R: PD of a router

(Registering Logical Specs <Preliminary Operations>)

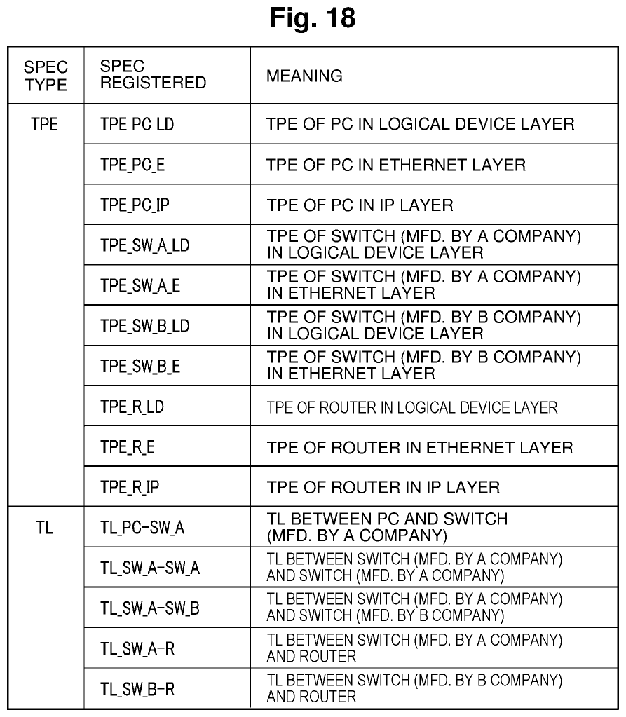

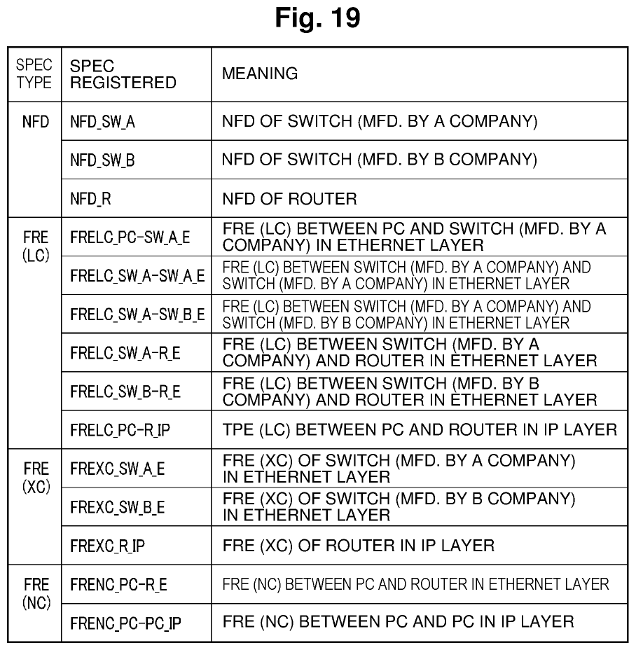

FIGS. 18 and 19 are diagrams showing tables of exemplary logical specs input by the spec input unit. The spec input unit 41 registers the logical specs shown in FIGS. 18 and 19 in the spec DB 12a through the operator's operations.

Each logical spec includes the spec type, the spec registered, and the meaning.

The following shows the correspondences “expression of spec registered: meaning” for each of the types TPE and TL of the logical specs registered in the example shown in FIG. 18.

(TPE)

TPE_PC_LD: TPE of a PC in Logical Device layer

TPE_PC_E: TPE of a PC in Ethernet layer

TPE_PC_IP: TPE of a PC in IP layer

TPE_SW_A_LD: TPE of a switch (manufactured by A company) in Logical Device layer

TPE_SW_A_E: TPE of a switch (manufactured by A company) in Ethernet layer

TPE_SW_B_LD: TPE of a switch (manufactured by B company) in Logical Device layer

TPE_SW_B_E: TPE of a switch (manufactured by B company) in Ethernet layer

TPE_R_LD: TPE of a router in Logical Device layer

TPE_R_E: TPE of a router in Ethernet layer

TPE_R_IP: TPE of a router in IP layer

(TL)

TL_PC-SW_A: TL between a PC and a switch (manufactured by A company)

TL_SW_A-SW_A: TL between a switch (manufactured by A company) and a switch (manufactured by A company)

TL_SW_A-SW_B: TL between a switch (manufactured by A company) and a switch (manufactured by B company)

TL_SW_A-R: TL between a switch (manufactured by A company) and a router

TL_SW_B-R: TL between a switch (manufactured by B company) and a router

The following shows the correspondences “expression of spec registered: meaning” for each of the types NFD, FRE (LC), FRE (XC), and FRE (NC) of the logical specs registered in the example shown in FIG. 19.

(NFD)

NFD_SW_A: NFD of a switch (manufactured by A company)

NFD_SW_B: NFD of a switch (manufactured by B company)

NFD_R: NFD of a router

(FRE (LC))

FRELC_PC-SW_A_E: FRE (LC) between a PC and a switch (manufactured by A company) in Ethernet layer

FRELC_SW_A-SW_A_E: FRE (LC) between a switch (manufactured by A company) and a switch (manufactured by A company) in Ethernet layer

FRELC_SW_A-SW_B_E: FRE (LC) between a switch (manufactured by A company) and a switch (manufactured by B company) in Ethernet layer

FRELC_SW_A-R_E: FRE (LC) between a switch (manufactured by A company) and a router in Ethernet layer

FRELC_SW_B-R_E: FRE (LC) between a switch (manufactured by B company) and a router in Ethernet layer

FRELC_PC-R_IP: FRE (LC) between a PC and a router in IP layer

(FRE (XC))

FREXC_SW_A_E: FRE (XC) of a switch (manufactured by A company) in Ethernet layer

FREXC_SW_B_E: FRE (XC) of a switch (manufactured by B company) in Ethernet layer

FREXC_R_IP: FRE (XC) of a router in IP layer

(FRE (NC))

FRENC_PC-R_E: FRE (NC) between a PC and a router in Ethernet layer

FRENC_PC-PC_IP: FRE (NC) between a PC and a PC in IP layer

(Correspondences Between NW and Physical Specs <Preliminary Operations>)

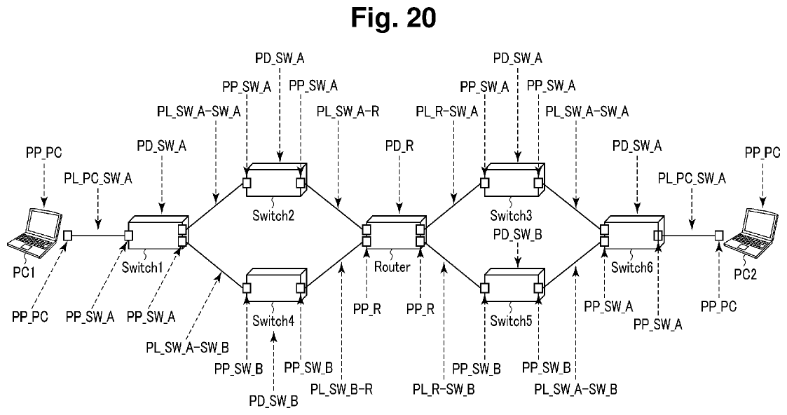

FIG. 20 is a diagram showing exemplary correspondences between the managed network and the physical specs. FIG. 20 shows the correspondences of the physical specs registered in the spec DB 12a and shown in FIG. 17 with PP, PL, and PD in the managed NW shown in FIG. 16.

(Process of Registering Physical Entities <Preliminary Operations>)

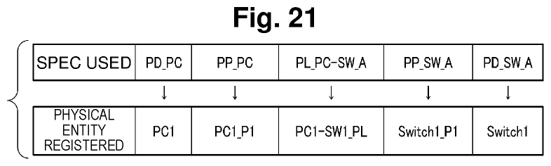

FIGS. 21, 22, and 23 are diagrams showing exemplary physical entity registration.

The entity input unit 42 uses the above registered physical-layer specs to register the physical entities in the entity DB 12b through the operator's operations.

FIG. 21 shows the correspondences of physical entity information registered using physical-layer specs.

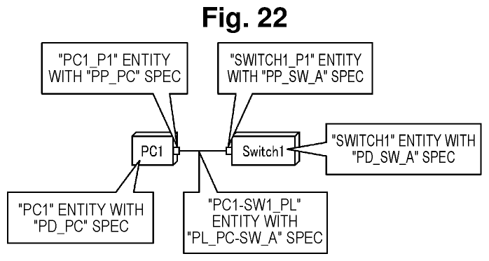

The physical entities shown in FIG. 21 are denoted in the form shown in FIG. 22. Adjacent entities have a mutual connection relationship. FIG. 22 shows the physical entities from PC1 to Switch1 shown in FIG. 21.

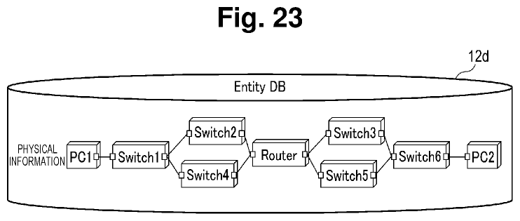

As shown in FIG. 23, the physical entities are preparatorily registered in the entity DB 12b. These entities have correspondences with the physical specs as in FIG. 21.

The following (a) to (e) show the relationships shown in FIG. 21 between the specs used and the physical entities registered, and the corresponding expression shown in FIG. 22.

(a)

(spec used) PD_PC

(physical entity registered) PC1

(expression of physical entity) “PC1” entity with “PD_PC” spec

(b)

(spec used) PP_PC

(physical entity registered) PC1_P1

(expression of physical entity) “PC1_P1” entity with “PP_PC” spec

(c)

(spec used) PL_PC-SW_A

(physical entity registered) PC1-SW1_PL

(expression of physical entity) “PC1-SW1_PL” entity with “PL_PC-SW_A” spec

(d)

(spec used) PP_SW_A

(physical entity registered) Switch1_P1

(expression of physical entity) “Switch1_P1” entity with “PP_SW_A” spec

(e)

(spec used) PD_SW_A

(physical entity registered) Switch1

(expression of physical entity) “Switch1” entity with “PD_SW_A” spec

(Setting Accommodation Information <Preliminary Operations>)

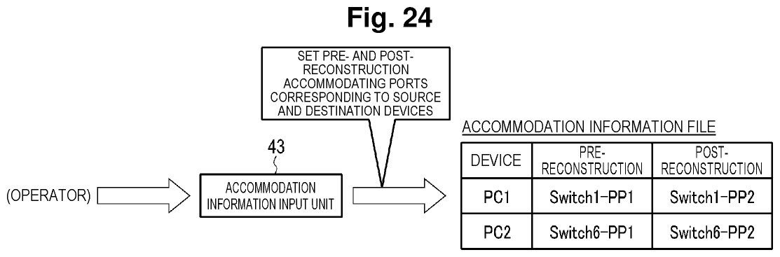

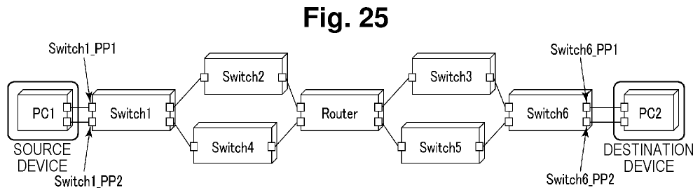

FIGS. 24 and 25 are diagrams showing exemplary accommodation information setting.

The accommodation information input unit 43 sets an accommodation information file through the operator's operations. The accommodation information file includes the PP entities, which are the pre- and post-reconstruction accommodating ports, corresponding to each of the source device and the destination device.

In the example shown in FIG. 24, the accommodation information input unit 43 stores, in the accommodation information file DB 12c, an accommodation information file that includes PP entities (a) to (d) below in the managed NW shown in FIG. 25.

(a) the PP entity “Switch1_PP1,” which is the pre-reconstruction accommodating port corresponding to the port of Switch1 accommodating the pre-reconstruction source device PC1

(b) the PP entity “Switch6_PP1,” which is the pre-reconstruction accommodating port corresponding to the port of Switch6 accommodating the pre-reconstruction destination device PC2

(c) the PP entity “Switch1_PP2,” which is the post-reconstruction accommodating port corresponding to the port of Switch1 accommodating the post-reconstruction source device PC1

(d) the PP entity “Switch6_PP2,” which is the post-reconstruction accommodating port corresponding to the port of Switch6 accommodating the post-reconstruction destination device PC2

(Setting Device Configuration Rules <Preliminary Operations>)

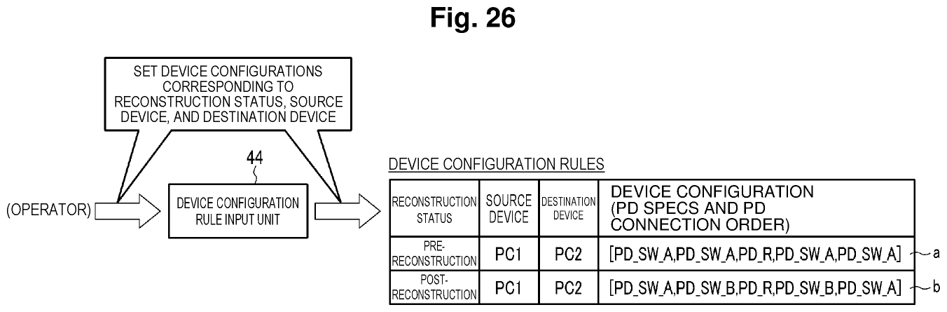

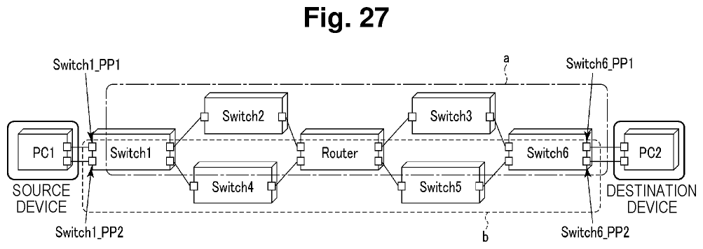

FIGS. 26 and 27 are diagrams showing exemplary device configuration rule setting.

The device configuration rule input unit 44 sets PD spec arrays through the operator's operations. Each PD spec array indicates a device configuration (PD specs and the PD connection order), corresponding to a reconstruction status and the source and destination devices.

In the example shown in FIG. 26, the device configuration rule input unit 44 stores, in the device configuration rule file DB 12d, device configuration rules including PD spec arrays (a) and (b) below in the managed NW shown in FIG. 27.

(a) the PD spec array [PD_SW_A, PD_SW_A, PD_R, PD_SW_A, PD_SW_A] (“a” in FIG. 26) corresponding to the device configuration (“a” in FIG. 27) between the source device PC1 and the destination device PC2 for the reconstruction status “pre-reconstruction”

(b) the PD spec array [PD_SW_A, PD_SW_B, PD_R, PD_SW_B, PD_SW_A] (“b” in FIG. 26) corresponding to the device configuration (“b” in FIG. 27) between the source device PC1 and the destination device PC2 for the reconstruction status “post-reconstruction”

(Calculating Paths <Path Selection Operations>)

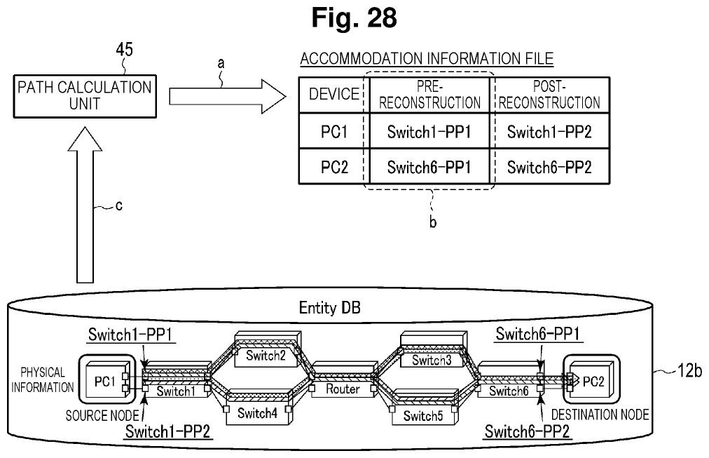

FIG. 28 is a diagram showing exemplary path calculation.

(1) The path calculation unit 45 obtains, from the accommodation information file DB 12c, the PP entities of the accommodating ports for the source and destination devices, corresponding to the reconstruction status and the source and destination devices “PC1” and “PC2” (“a” in FIG. 28).

(2) The path calculation unit 45 calculates all pre- or post-reconstruction paths from the accommodating port for the source device to the accommodating port for the destination device by following the connection relationships of the PP and PL entities stored in the entity DB 12b between the PP entities obtained as above. The path calculation unit 45 thus obtains the PD, PL, and PP entities in each path from the entity DB 12b.

In the example shown in FIG. 28, the path calculation unit 45 obtains (a) and (b) below from the accommodation information file shown in FIG. 24.

(a) the PP entity “Switch1_PP1,” which is the pre-reconstruction accommodating port corresponding to the port of Switch1 accommodating the pre-reconstruction source device PC1

(b) the PP entity “Switch6_PP1,” which is the pre-reconstruction accommodating port corresponding to the port of Switch6 accommodating the pre-reconstruction destination device PC2

The path calculation unit 45 calculates paths (1) to (4) below between the port for the source device and the port for the destination device indicated by the PP entities obtained, and obtains the PD, PL, and PP entities in all the paths (“b” in FIG. 28). Only the PD entities obtained are shown below.

path (1): Sw1_A→Sw2_A→R→Sw3_A→Sw6_A

path (2): Sw1_A→Sw2_A→R→Sw5 B→Sw6_A

path (3): Sw1_A→Sw4 B→R→Sw3_A→Sw6_A

path (4): Sw1_A→Sw4 B→R→Sw5 B→Sw6_A

The following shows the meaning of the above expressions.

Sw1_A, Sw2_A, Sw3_A, Sw6_A, and Sw1_A: Switch1, Switch2, Switch3, and Switch6 (manufactured by A company)

Sw4_B and Sw5_B: Switch4 and Switch5 (manufactured by B company)

R: Router

(Assessing Paths <Path Selection Operations>)

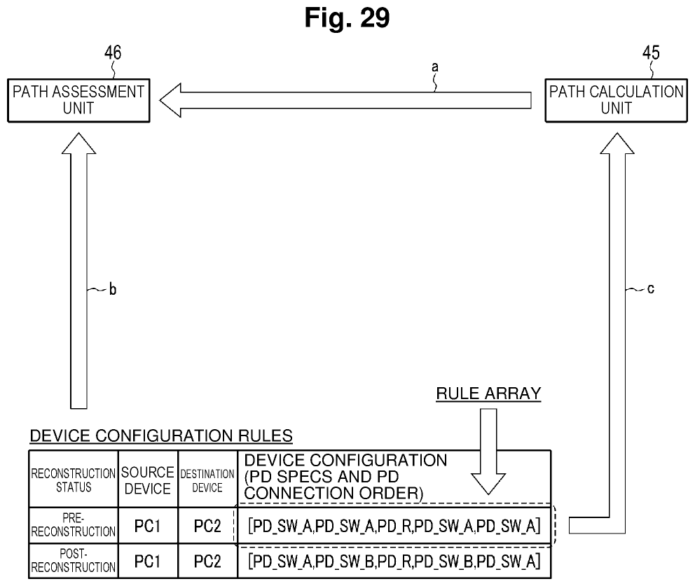

FIG. 29 is a diagram showing exemplary path calculation.

(1) The path assessment unit 46 obtains the PD entities in each path obtained by the path calculation unit 45 and stores PD specs corresponding to the PD entities in an array, thus generating a calculated array for each path (“a” in FIG. 29).

(2) The path assessment unit 46 obtains, from the device configuration rule file DB 12d, a device configuration corresponding to the reconstruction status and to the source and destination devices. From this device configuration, the path assessment unit 46 obtains a PD spec array and thus generates a rule array (“b” in FIG. 29).

(3) The path assessment unit 46 compares the PD specs in the calculated array for one of the paths with the PD specs in the rule array corresponding to the reconstruction status, source device, and destination device for the calculated array. If the compared two arrays indicate the same PD specs in the same order, the path assessment unit 46 assesses the calculated path as a path that meets the device configuration rule, and returns the path to the path calculation unit 45. If the two arrays do not satisfy the condition that they indicate the same PD specs in the same order, the path assessment unit 46 selects another one of the paths yet to be assessed and assesses the selected path, i.e., generates a calculated array and compares it with the rule array as above.

In the example shown in FIG. 29, the path assessment unit 46 obtains the PD entities in the paths (1) to (4) shown in FIG. 28 and generates calculated arrays (a) to (d) below that store PD specs corresponding to these PD entities.

(a) path (1): [PD_SW_A, PD_SW_A, R, PD_SW_A, PD_SW_A]

(b) path (2): [PD_SW_A, PD_SW_A, R, PD_SW_B

PD_SW_A]

(c) path (3): [PD_SW_A, PD_SW_B, R, PD_SW_A, PD_SW_A]

(d) path (4): [PD_SW_A, PD_SW_B, R, PD_SW_B, PD_SW_A]

The path assessment unit 46 obtains a rule array by obtaining a device configuration corresponding to the reconstruction status and to the source and destination devices.

The path assessment unit 46 compares the calculated array of each path with the rule array. The comparison suggests that the calculated array of the path (1) and the rule array for the path (1) indicate the same PD specs in the same order. The path assessment unit 46 therefore assesses the path (1) as a pre-reconstruction path that meets the device configuration rule, and returns the PD entities in the path to the path calculation unit 45 (“c” in FIG. 29).

(Adding Logical Entities <Path Selection Operations>)

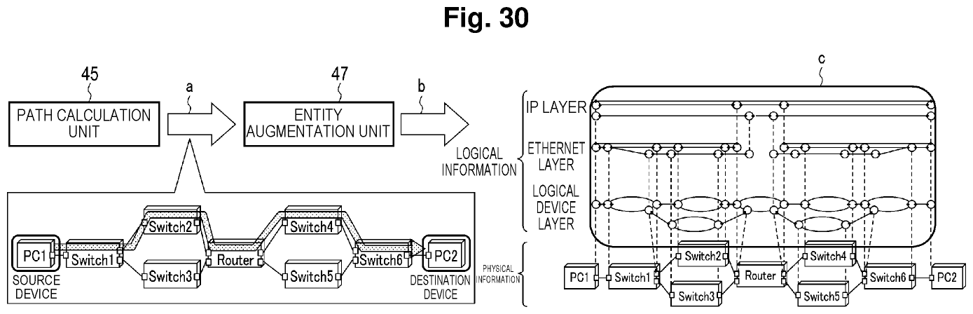

FIG. 30 is a diagram for describing exemplary logical entity addition.

(1) The path calculation unit 45 inputs the physical entities (PP/PL/PD) in the above calculated path to the entity augmentation unit 47 (“a” in FIG. 30).

(2) The entity augmentation unit 47 automatically generates logical entities corresponding to the input physical entities from logical specs and adds the logical entities (“b” in FIG. 30).

To add the logical entities, the entity augmentation unit 47 obtains specs from the spec DB 12a. Using the specs obtained, the entity augmentation unit 47 generates logical-layer entities (which may be referred to as logical entities) corresponding to the above input physical entities (PP/PL/PD). The logical entities generated maintain the relationships between entities in the logical layers, and the relationships of entities in the lowest logical layer with entities in the physical layer.

The addition of logical entities by the entity augmentation unit 47 is also described in Japanese Patent Application No. 2019-031788 specification (e.g., claim 1, paragraphs [0040] to [0142], and FIGS. 9 to 42).

As described above, the path calculation unit 45 in the network management system according to an embodiment of the present invention obtains, from the accommodation information file, the PP entities of the source and destination ports corresponding to the reconstruction status and to the source and destination devices. The path calculation unit 45 calculates paths between the source and destination PP entities corresponding to the reconstruction status and obtains PD, PL, and PP entities in each of these paths.

The path assessment unit 46 obtains the PD entities in each path obtained by the path calculation unit 45 and stores PD specs corresponding to these entities in an array referred to as a calculated array. The path assessment unit 46 obtains, from the device configuration rule file, a device configuration corresponding to the reconstruction status and to the source and destination devices. From this device configuration, the path assessment unit 46 obtains a PD spec array to be used as a rule array.

The path assessment unit 46 compares the PD specs in each calculated array and the PD specs in the rule array. If the two arrays indicate the same PD specs in the same order, the path assessment unit 46 assesses the path as a path that meets the device configuration rule, and returns the path to the path calculation unit 45.

The path calculation unit 45 inputs, to the entity augmentation unit 47, the physical entity group included in the path returned from the path assessment unit 46. The entity augmentation unit 47 automatically generates logical entities corresponding to the physical entities.

The above-described features enable a designer of the network management system to use design information to automatically obtain pre- and post-reconstruction paths in both physical and logical layers.

The techniques described in the embodiments may be distributed as a computer-executable program (software means) by storing the program on a recording medium, for example a magnetic disk (such as a floppy (R) disk or hard disk), an optical disc (such as a CD-ROM, DVD, or MO), or semiconductor memory (such as ROM, RAM, or flash memory), or by transmitting the program through a communication medium. The program stored on the medium includes a setup program for causing the computer-executed software means (including an executable program as well as tables and data structures) to be configured in the computer. The computer implementing the inventive device performs the above-described processes by reading the program recorded on the recording medium, and possibly causing the setup program to build the software means so that the software means controls the operation of the computer. A recording medium as used herein includes a storage medium to be distributed, as well as a storage medium, such as a magnetic disk or semiconductor memory, provided in a computer or in a device connected to the computer over a network.

The present invention is not limited to the above embodiments but, in practice, encompasses various modifications within the spirit of the invention. The embodiments may be appropriately combined to achieve combined effects. Further, the above embodiments include various aspects of the invention, and different aspects of the invention may be extracted by combinations of elements selected from the elements disclosed. For example, if a configuration that lacks some of the elements illustrated in the embodiments can still solve problems and achieve advantageous effects, that configuration may be extracted as an aspect of the invention.

### REFERENCE SIGNS LIST

10 Network management system
41 Spec input unit
42 Entity input unit
43 Accommodation information input unit
44 Device configuration rule input unit
45 Path calculation unit
46 Path assessment unit
47 Entity augmentation unit

1. A network management device comprising:
a first storage unit that stores entities representing substances of information objects in a network;
a second storage unit that stores information on a start point and an end point of the network;
a third storage unit that stores information on a rule of a path indicating types of and a connection order of a plurality of communication devices provided between the start point and the end point of the network;
a processor; and
a storage medium having computer program instructions stored thereon, when executed by the processor, perform to:
obtaining the information on the start point and the end point of the network from the second storage unit, and
calculating, based on the entities stored in the first storage unit, a plurality of physical-layer paths between the start point and the end point of the network and obtaining entities between the start point and the end point in each of the plurality of physical-layer paths from the first storage unit; and
assessing a path indicated by the entities obtained by the path calculation processing means as a path that meets the rule if the path, indicating types of and a connection order of a plurality of communication devices provided between the start point and the end point of the network in the path, meets the rule stored in the third storage unit.

2. The network management device according to claim 1, wherein
the second storage unit stores the information on the start point and the end point of the network in association with reconstruction status information indicating a pre-reconstruction status or a post-reconstruction status of the network,
the third storage unit stores, in association with the reconstruction status information indicating the pre-reconstruction status or the post-reconstruction status of the network, the information on the rule of the path indicating the types of and the connection order of the plurality of communication devices provided between the start point and the end point of the network,
the computer program instructions further perform to
obtains, from the second storage unit, the information on the start point and the end point of the network for one of the pre-reconstruction status or the post-reconstruction status of the network, and
calculates, based on the entities stored in the first storage unit, a plurality of physical-layer paths between the start point and the end point of the network for the one of the pre-reconstruction status or the post-reconstruction status of the network and obtains entities between the start point and the end point in each of the plurality of physical-layer paths from the first storage unit, and
assesses a physical-layer path for the one of the pre-reconstruction status or the post-reconstruction status of the network indicated by the entities obtained by the path calculation processing means as a physical-layer path that meets the rule if the physical-layer path, indicating types of and a connection order of a plurality of communication devices provided between the start point and the end point of the network in the physical-layer path, meets the rule stored in the third storage unit.

3. The network management device according to claim 1, comprising a fourth storage unit that stores specifications of the information objects, wherein the computer program instructions further perform to outputs physical-layer entities corresponding to the physical-layer paths calculated, and
generating, based on the specifications stored in the fourth storage unit, logical-layer entities according to the physical-layer entities.

4. A network management method performed by a network management device comprising: a first storage unit that stores first entities representing substances of information objects in a network; a second storage unit that stores information on a start point and an end point of the network; and a third storage unit that stores information on a rule of a path indicating types of and a connection order of a plurality of communication devices provided between the start point and the end point of the network, the method comprising:
performing path calculation processing comprising
obtaining the information on the start point and the end point of the network from the second storage unit, and
calculating, based on the entities stored in the first storage unit, a plurality of physical-layer paths between the start point and the end point of the network and obtaining entities between the start point and the end point in each of the plurality of physical-layer paths from the first storage unit; and
performing path assessment processing comprising assessing a path indicated by the entities obtained in the path calculation processing as a path that meets the rule if the path, indicating types of and a connection order of a plurality of communication devices provided between the start point and the end point of the network in the path, meets the rule stored in the third storage unit.

5. The network management method according to claim 4, wherein
the second storage unit stores the information on the start point and the end point of the network in association with reconstruction status information indicating a pre-reconstruction status or a post-reconstruction status of the network,
the third storage unit stores, in association with the reconstruction status information indicating the pre-reconstruction status or the post-reconstruction status of the network, the information on the rule of the path indicating the types of and the connection order of the plurality of communication devices provided between the start point and the end point of the network,
performing the path calculation processing comprises
obtaining, from the second storage unit, the information on the start point and the end point of the network for one of the pre-reconstruction status or the post-reconstruction status of the network, and
calculating, based on the entities stored in the first storage unit, a plurality of physical-layer paths between the start point and the end point of the network for the one of the pre-reconstruction status or the post-reconstruction status of the network and obtaining entities between the start point and the end point in each of the plurality of physical-layer paths from the first storage unit, and
performing the path assessment processing comprises assessing a physical-layer path for the one of the pre-reconstruction status or the post-reconstruction status of the network indicated by the entities obtained in the path calculation processing as a physical-layer path that meets the rule if the physical-layer path, indicating types of and a connection order of a plurality of communication devices provided between the start point and the end point of the network in the physical-layer path, meets the rule stored in the third storage unit.

6. The network management method according to claim 4, wherein
the network management device further comprises a fourth storage unit that stores specifications of the information objects,
performing the path calculation processing comprises outputting physical-layer entities corresponding to the physical-layer paths calculated, and
the method further comprises performing entity generation processing comprising generating, based on the specifications stored in the fourth storage unit, logical-layer entities according to the physical-layer entities output in the path calculation processing.

7. A non-transitory computer-readable medium having computer-executable instructions that, upon execution of the instructions by a processor of a computer, cause the computer to function as the network management device according to claim 1.
